(19) United States
(12) Patent Application Publication
(10) Pub. No.: US 2010/0074183 A1
(43) Pub. Date: Mar. 25, 2010

(54) MODE SWITCHING FOR A DOWNLINK COORDINATED MULTIPOINT COMMUNICATION

(75) Inventors: Runhua Chen, Dallas, TX (US); Eko N. Onggosanusi, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/566,450

(22) Filed: Sep. 24, 2009

Related U.S. Application Data
(60) Provisional application No. 61/099,956, filed on Sep. 25, 2008.

(51) Int. Cl. H04W 88/00; H04B 7/02

(52) U.S. Cl. 370/328; 455/101

(57) ABSTRACT

A mode-switching network transmitter is for use with a network MIMO super cell and includes a super cell control unit configured to orchestrate a transmission from the network MIMO super cell, wherein the transmission is supplied from a portion of super cell transmission points. The mode-switching network transmitter also includes a transmission unit configured to provide the transmission. Additionally, a transmission mode-switching receiver is for use with user equipment in a network MIMO super cell and includes a reception unit configured to receive a transmission for the user equipment within the network MIMO super cell. The transmission mode-switching receiver also includes a processing unit configured to process the transmission, wherein the transmission is supplied from a portion of super cell transmission points.

### CROSS-REFERENCE TO RELATED APPLICATION

This application claims the benefit of U.S. Provisional Application Ser. No. 61/099,956, filed by Runhua Chen, et al. on Sep. 25, 2008, entitled “SEMI-STATIC MODE SWITCHING FOR DOWNLINK COORDINATED MULTI-POINT (COMP) COMMUNICATION,” commonly assigned with this application and incorporated herein by reference.

### TECHNICAL FIELD

This application is directed, in general, to a communication system and, more specifically, to a mode-switching network transmitter, a transmission mode-switching receiver and methods of operating a mode-switching network transmitter and a transmission mode-switching receiver.

### BACKGROUND

In a cellular network, such as one employing orthogonal frequency division multiple access (OFDMA), each cell employs a base station that communicates with user equipment. MIMO communication systems offer large increases in throughput due to their ability to support multiple parallel data streams that are each transmitted from different antennas. These systems provide increased data rates and reliability by exploiting a spatial multiplexing gain or spatial diversity gain that is available to MIMO channels. Although current data rates are adequate, improvements in this area would prove beneficial in the art.

### SUMMARY

Embodiments of the present disclosure provide embodiments of a mode-switching network transmitter, a transmission mode-switching receiver and methods of operating a mode-switching network transmitter and a transmission mode-switching receiver.

In one embodiment, the mode-switching network transmitter is for use with a network MIMO super cell and includes a super cell control unit configured to orchestrate a transmission from the network MIMO super cell, wherein the transmission is supplied from a portion of super cell transmission points. The mode-switching network transmitter also includes a transmission unit configured to provide the transmission.

In another embodiment, the transmission mode-switching receiver is for use with user equipment in a network MIMO super cell and includes a reception unit configured to receive a transmission for the user equipment within the network MIMO super cell. The transmission mode-switching receiver also includes a processing unit configured to process the transmission, wherein the transmission is supplied from a portion of super cell transmission points.

In another aspect, the method of operating a mode-switching network transmitter is for use with a network MIMO super cell and includes orchestrating a transmission from the network MIMO super cell, wherein the transmission is supplied from a portion of super cell transmission points and also includes providing the transmission.

In yet another aspect, the method of operating a transmission mode-switching receiver is for use with user equipment in a network MIMO super cell and includes receiving a transmission for the user equipment within the network MIMO super cell and processing the transmission, wherein the transmission is supplied from a portion of super cell transmission points.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

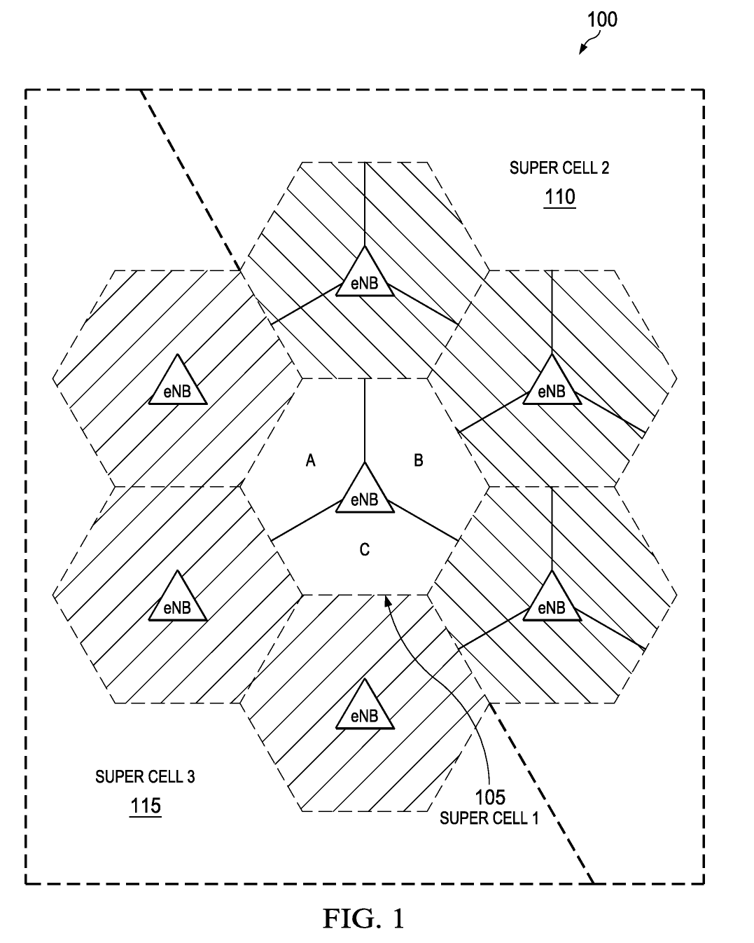

FIG. 1 illustrates a diagram of an exemplary cellular wireless network constructed according to the principles of the present disclosure;

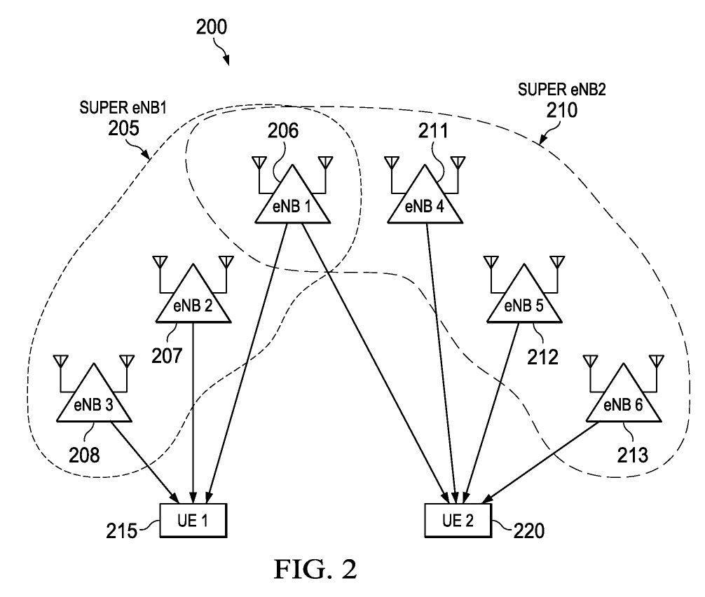

FIG. 2 illustrates a more general example of a network MIMO constructed according to the principles of the present disclosure;

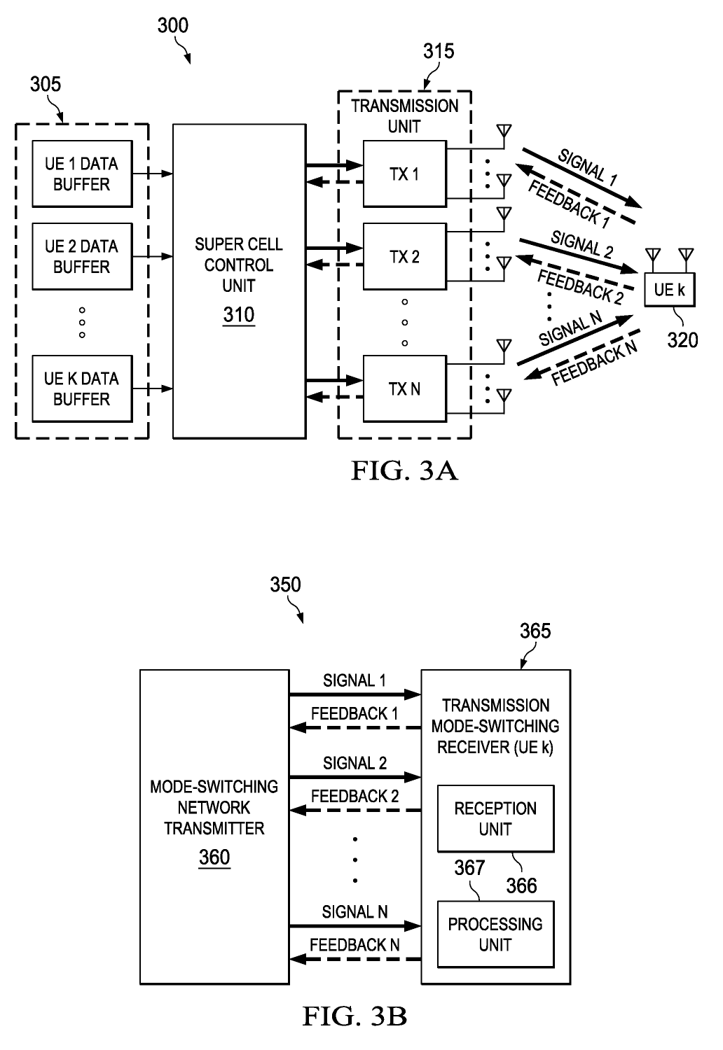

FIGS. 3A and 3B illustrate diagrams of a mode-switching network transmitter as may be employed as a super eNB of a network MIMO super cell, and a transmission mode-switching receiver as may be employed in the network MIMO super cell;

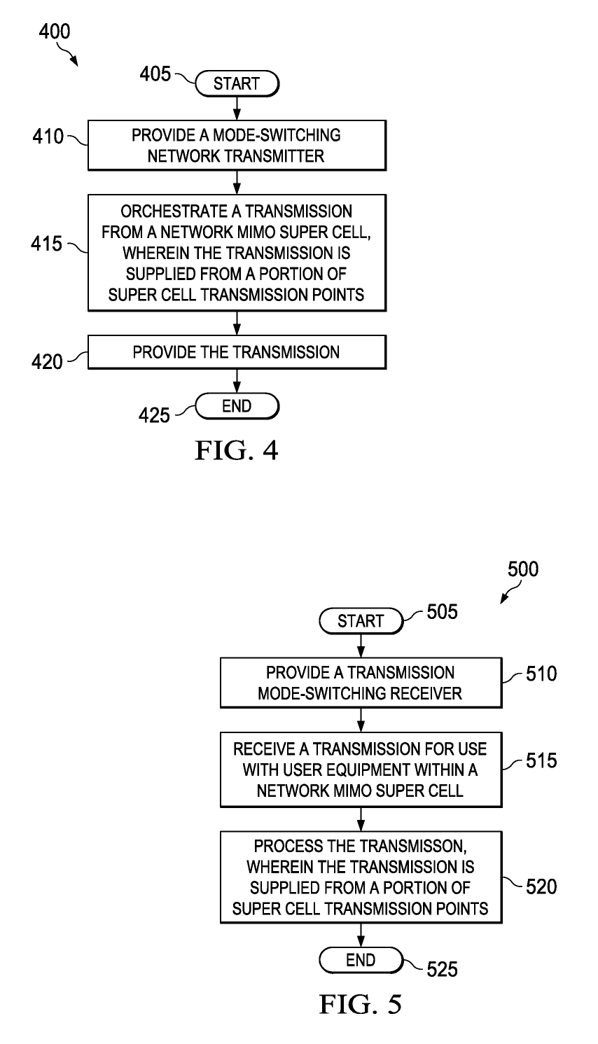

FIG. 4 illustrates a flow diagram of an embodiment of a method of operating a mode-switching network transmitter carried out according to the principles of the present disclosure; and

FIG. 5 illustrates a flow diagram of an embodiment of a method of operating a transmission mode-switching receiver carried out according to the principles of the present disclosure.

### DETAILED DESCRIPTION

Beyond long term evolution (LTE) Release 8, a performance improvement of throughput is required in both downlink (DL) and uplink (UL) systems. One possible technology enhancement is to use network MIMO employing multiple evolved base stations (eNBs) that collaborate to serve user equipment (UE) in DL or UL interactions. Several eNBs may be combined to form a super eNB that shares traffic information or control information, for example. This is typically referred to as Network MIMO or Coordinated Multi-point (COMP) transmission. A group of communication cells over which a transmission is coordinated by the super eNB is denoted as a super cell.

From a conventional network management perspective, several interference sources exist, such as co-channel interference from other cells, which degrade system throughput. However, this interference may be reduced substantially by utilizing a network MIMO (COMP) system wherein collaborative information provided by eNBs within the super eNB is employed to improve throughput while reducing interference.

FIG. 1 illustrates a diagram of an exemplary cellular wireless network 100 constructed according to the principles of the present disclosure. The cellular wireless network 100 includes a cellular grid having multiple cells or sectors. Note that a cell is defined as a geographic area where UEs are served by a single network identity (e.g., a base station). In practice, a cell can be of any physical shape and is not restricted to be a hexagon. For example in FIG. 1, each of the three sectors A, B, C may also be defined as a cell. The cellular wireless network 100 is representative of a network MIMO structure that is divided into a plurality of super cells 105, 110, 115, where a super cell consists of a cluster of cells or sectors and performs coordinated multipoint transmission within the super cell. Each of the super cells may employ a mode-switching network transmitter.

Depending on the cell and network topology, multiple cells may be associated with a single base station (eNB), such as the first super cell 105. In this example, a super cell is formed from the three sectors A, B, C associated with a single eNB, as shown. That is, one eNB may send three different signals, where each of the three different signals is associated with a separate sector. Alternatively, it is possible to form a super cell consisting of two or more cells, where each cell is associated with a different eNB, as shown for the second and third super cells 110, 115. In the illustrated example, the second super cell 110 may also employ individual sectors for each of the cells, as noted above.

FIG. 2 illustrates a more general example of a network MIMO 200 constructed according to the principles of the present disclosure. The network MIMO 200 includes first and second super cells 205, 210, and first and second user equipment (UE) 215, 220. The first super cell 205 employs a first cluster or set of eNBs (i.e., a super eNB) that includes first, second and third eNBs 206, 207, 208. Correspondingly, the second super cell 210 employs a second set of eNBs or super eNB that includes the first eNB 106 and fourth, fifth and sixth eNBs 211, 212, 213.

As seen in FIG. 2, the number of eNBs associated with each super eNB can be different. Additionally, it is possible to configure the number and indices of eNBs associated with each super eNB based on network topologies, which may include for example, cell size or traffic type (i.e., highly-loaded cells versus lowly-loaded cells).

The super eNB may be configured to function when the same channel state information is available at each of the individual eNBs, such as through a central controller. Alternatively, the super eNB may be configured to function when channel state information is not generally available at all individual eNBs. In this case, the super eNB functions more like multiple “distributed” eNBs.

The individual eNBs associated with a super eNB may send the same data to a target UE (e.g., the first or second UE 215, 220). Alternatively, different eNBs may send different data to the target UE. In general, there may be some degree of overlap across the data sent from a set of eNBs associated with different cells to the target UE.

The set of eNBs associated with each super eNB may be semi-statically configured by a network higher-layer. Although it is possible to configure the super eNB dynamically, this may serve to limit performance compared to semi-static configuring. Furthermore, from the perspective of reducing the signaling overhead and configuration complexity in physical layer and backhaul areas, a semi-static configuring of the super-eNB may be generally sufficient and therefore appropriate.

FIGS. 3A and 3B illustrate diagrams of a mode-switching network transmitter 300 as may be employed as a super eNB of a network MIMO super cell, and a transmission mode-switching receiver 350 as may be employed by user equipment in the network MIMO super cell. The mode-switching network transmitter 300 includes a plurality of data buffers 305 corresponding to a plurality of user equipment (UE), a super cell control unit 310 and a transmission unit 315 that provides a transmission to a typical UEₖ 320, which is representative of all UEs operating within the network MIMO super cell. The transmission unit 315 includes a set of N super cell transmission points TX₁-TX_{N}, which may be associated with x≦N eNBs. The transmission mode-switching receiver 350 includes a reception unit 366 and a processing unit 367.

In the illustrated embodiment, the super cell control unit 310 is configured to orchestrate a transmission from the network MIMO super cell, wherein the transmission is supplied from a portion of the super cell transmission points TX₁-TX_{N}. The transmission unit 315 is configured to provide the transmission. The transmission mode-switching receiver 350 is employed by the typical UEₖ 320 where the reception unit 366 is configured to receive a transmission within the network MIMO super cell, and the processing unit 367 is configured to process the transmission, wherein the transmission is supplied from a portion of the super cell transmission points TX₁-TX_{N}.

Generally, the transmission from the network MIMO super cell (the super cell) corresponds to geographically separated or co-located transmission points wherein a transmission point may generally be a base station transmitter, an enhanced base station (eNB) transmitter, a distributed antenna or a radio remote head (RRH), for example.

In the illustrated embodiment, each of the super cell transmission points TX₁-TX_{N} may be associated with one cell. Recall that a three-cell site, where the cells are formed by sectorization beams, may form a three-cell super cell associated with a single eNB. Alternatively, three single-cell sites may form a three-cell super cell consisting of three eNBs.

For a given resource block (RB), a UE (e.g., the typical UEₖ 320) may receive a transmission from a total of N_{TX} super cell transmission points, where N_{TX}ε{0,1,2, . . . , N}. The UE may report a set of feedback parameters to the super cell. Similarly, the UE may report to N_{FB} transmitters, where N_{FB}ε{1,2, . . . , N}. The feedback parameters may include a channel quality indicator (CQI), a precoding matrix indicator (PMI), and a rank indicator (RI), for example. Within a given cell, each RB is assigned to only one UE, for single-user MIMO.

The number of transmit antennas for a super cell transmission point TX_{N} may be denoted as Pₙ and the number of UE antennas as Q. Hence, the maximum number of transmission layers from the mode-switching network transmitter 300 (i.e., a collective transmitter or super cell) to the UE is

$$min ( Q , {\sum }_{n = 1}^{N} {P}_{n} ) .$$

A joint transmission scheme, generally based on the above characteristics, involving UE reporting strategy and joint scheduling or link adaptation are addressed below.

Within a given RB, an idealized transmission to a UE of interest may involve the following capabilities. A super cell may dynamically adapt the subset of N_{TX}ε{0,1,2, . . . , N} taken from the N available super cell transmission points to optimize the average throughput across all N cells based on an instantaneous channel. This adaptation is necessary for optimality, since generally receiving transmissions from all N super cell transmission points TX₁-TX_{N} is sub-optimal when channels associated with some of the transmitters are poor. Hence, such transmission points may better serve other UEs. There are 2^{N} possibilities.

The super cell is able to perform joint precoding, rank adaptation and MCS selection involving all the selected N_{TX} super cell transmission points TX₁-TX_{N} or cells. Hence, a joint codebook is required for all the possible dimensions. The UE receives a single joint transmission rather than several individual transmissions. Therefore, a UE receiver (e.g., the transmission mode-switching receiver 365) processes the single joint transmission in the symbol-level (thereby attaining symbol-level combining gain).

To enable the above capabilities, the UE reports the joint {CQI, PMI, RI} to the super cell for each of the 2^{N}-1 possible combinations of super cell transmission points TX₁-TX_{N} involving N_{FB}ε{1,2, . . ., N}. Denoting a subset of all possible combinations of transmission points TX₁-TX_{N} as Sε{S₁,S₂, . . . ,S₂_{^{N}}₋₁} and a joint report Γ(Sᵢ) (consisting of CQI, PMI, and RI associated with the joint transmission) corresponding to a transmission point combination Sᵢ, the UE reports {Γ(S₁),Γ(S₂), . . . ,Γ(S₂_{^{N}}₋₁)}. Here, S₁ is defined as the subset containing only the first super cell transmission point TX₁ and S_{2N-1} as the full set containing all the N super cell transmission points TX₁-TX_{N}.

Correspondingly, the joint report Γ(Sᵢ) assumes that all transmission points in the subset Sᵢ are signal sources, while the other transmission points ({1,2, . . . ,N}-Sᵢ) as well as other transmitters within the network (but not in the super cell) are interference sources.

Since the idealized transmission to a UE of interest may be impractical due to an excessive amount of required UE feedback, a subset of participating transmission points and joint reporting is considered below. It may be noted that a subset of participating transmission points S̅ᵢ and reporting quantities Γ( S̅ᵢ) may be selected that does not change rapidly. Therefore, it is possible to semi-statically configure the subset of participating transmission points S̅ᵢ and reporting quantities Γ( S̅ᵢ) based on appropriate long-term channel statistics, such as a shadowing or path-loss model. This configuration is typically UE-specific, since the optimum subset mainly depends on the UE position relative to its super cell transmission points and signal scattering objects (i.e., “scatterers”).

A UE can be semi-statically configured to be in a network MIMO mode (i.e., receiving a data transmission from more than one super cell transmission point) or in a single-cell mode (i.e., receiving a data transmission from only one transmission point per super cell and treating other cells as interference).

For example, if a UE is at an edge between adjacent cells, its received signal from the cells may both be strong. Hence, it is beneficial to configure this UE in a network MIMO mode to receive data from multiple strong transmission points in order to avoid co-channel interference. In this case, the UE reports channel state information associated with only a subset of strong signals, where the subset can be semi-statically configured by a network controller or determined by a UE measurement. Optimally, the UE may assume that a downlink data transmission originates from a subset of transmission points, where the subset of data transmission points for the data transmission may be signaled by the eNB. Alternately, the UE may assume it is the same subset of points for channel reporting.

Alternatively, if a UE is near the center of a cell, the received signal from other cells may be weak or small and does not significantly contribute to the UE throughput. In this case, it is typically beneficial to configure this UE in a single-cell mode, where the UE reports only the channel associated with the single cell (e.g., an anchor cell to which the UE is synchronized) and receives a data transmission from this single-cell transmission point. The other cells or transmission points may be employed to serve other UEs in the same transmission spectrum, as may be required.

A semi-static mode configuration may be based on a UE measurement such as comparing channel state indicators (CSIs) that is associated with all N different super cell transmission points or cells, for example. For a UE, one embodiment of mode switching and selection of S̅ᵢ may involve identifying cells whose

CSI is greater than a threshold for a performance target of the UE. Super cell transmission points whose CSIs are greater than the threshold are then included in S̅ᵢ.

The performance target may be expressed as a function F(.) of UE measurements of transmission signals from the N super cell transmission points. The function F(.) may also be semi-statically configured by a super cell higher-layer or be UE-specific, as well.

For example, UE measurements may correspond to an RSRP (reference signal received power) or a geometry associated with the UE and its position relative to super cell transmission points. Such measurements may be denoted as P_1,P_2, . . . ,P_N. Examples of a function F(P_1,P_{—}2, . . . ,P_N) may include maximum, median or average arithmetic or geometric values that are pertinent to the UE measurement.

If the super cell control unit 310 does not override the UE-reported mode configuration, then a UE that reports multiple super cell transmission points or cells in the subset of participating super cell transmission points S̅ᵢ is provided with a transmission configured in a network MIMO mode. Alternatively, a UE that reports a single super cell transmission point or cell in the subset of participating super cell transmission points S̅ᵢ is provided with a transmission configured in a single-cell MIMO mode.

It is also possible for the super cell controller 310 to override a mode of super cell operation reported by a UE. For example, it is possible for the super cell controller unit 310 to configure the UE in a single-cell mode, even though the UE reports multiple cells or multiple super cell transmission points for the subset of participating transmission points In this case, the UE will still receive a data transmission from a single cell or super cell transmission point configured by the super cell.

FIG. 4 illustrates a flow diagram of an embodiment of a method of operating a mode-switching network transmitter 400 carried out according to the principles of the present disclosure. The method 400 is for use with a network MIMO super cell and starts in a step 405. Then, in a step 410, a mode-switching network transmitter is provided, and a transmission from the network MIMO super cell is orchestrated, wherein the transmission is supplied from a portion of super cell transmission points, in a step 415.

In one embodiment, the portion of super cell transmission points corresponds to a single transmission point. In another embodiment, the portion of super cell transmission points as indicated by user equipment is overridden to provide the transmission from another portion of super cell transmission points. In yet another embodiment, the portion of super cell transmission points is semi-statically configured corresponding to a joint report from user equipment or a performance target for user equipment. In still another embodiment, the portion of super cell transmission points is semi-statically configured based on user equipment measurement of channel state indicators corresponding to all super cell transmission points. The transmission is provided in a step 420, and the method 400 ends in a step 425.

FIG. 5 illustrates a flow diagram of an embodiment of a method of operating a transmission mode-switching receiver 500 carried out according to the principles of the present disclosure. The method 500 is for use with user equipment in a network MIMO super cell and starts in a step 505. Then, in a step 510, a transmission mode-switching receiver is provided, and a transmission for the user equipment within the network MIMO super cell is received in a step 515. The transmission is processed, wherein the transmission is supplied from a portion of super cell transmission points in a step 520.

In one embodiment, the portion of super cell transmission points corresponds to a single transmission point determined by the user equipment. In another embodiment, the portion of super cell transmission points as indicated by the user equipment is overridden to provide the transmission from another portion of super cell transmission points. In yet another embodiment, the portion of super cell transmission points is semi-statically configured corresponding to a joint report from the user equipment or a performance target for the user equipment. In still another embodiment, the portion of super cell transmission points is semi-statically configured based on the user equipment measurement of channel state indicators corresponding to all super cell transmission points. The method 500 ends in a step 525.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A mode-switching network transmitter for use with a network MIMO super cell, comprising:
a super cell control unit configured to orchestrate a transmission from the network MIMO super cell, wherein the transmission is supplied from a portion of super cell transmission points; and
a transmission unit configured to provide the transmission.

2. The transmitter as recited in claim 1 wherein the portion of super cell transmission points corresponds to a single transmission point.

3. The transmitter as recited in claim 1 wherein the portion of super cell transmission points as indicated by user equipment is overridden to provide the transmission from another portion of super cell transmission points.

4. The transmitter as recited in claim 1 wherein the portion of super cell transmission points is semi-statically configured corresponding to a joint report from user equipment or a performance target for user equipment.

5. The transmitter as recited in claim 1 wherein the portion of super cell transmission points is semi-statically configured based on user equipment measurement of channel state indicators corresponding to all super cell transmission points.

6. A method of operating a mode-switching network transmitter for use with a network MIMO super cell, comprising:
orchestrating a transmission from the network MIMO super cell, wherein the transmission is supplied from a portion of super cell transmission points; and
providing the transmission.

7. The method as recited in claim 6 wherein the portion of super cell transmission points corresponds to a single transmission point.

8. The method as recited in claim 6 wherein the portion of super cell transmission points as indicated by user equipment is overridden to provide the transmission from another portion of super cell transmission points.

9. The method as recited in claim 6 wherein the portion of super cell transmission points is semi-statically configured corresponding to a joint report from user equipment or a performance target for user equipment.

10. The method as recited in claim 6 wherein the portion of super cell transmission points is semi-statically configured based on user equipment measurement of channel state indicators corresponding to all super cell transmission points.

11. A transmission mode-switching receiver for use with user equipment in a network MIMO super cell, comprising:
a reception unit configured to receive a transmission for the user equipment within the network MIMO super cell; and
a processing unit configured to process the transmission, wherein the transmission is supplied from a portion of super cell transmission points.

12. The receiver as recited in claim 11 wherein the portion of super cell transmission points corresponds to a single transmission point determined by the user equipment.

13. The receiver as recited in claim 11 wherein the portion of super cell transmission points as indicated by the user equipment is overridden to provide the transmission from another portion of super cell transmission points.

14. The receiver as recited in claim 11 wherein the portion of super cell transmission points is semi-statically configured corresponding to a joint report from the user equipment or a performance target for the user equipment.

15. The receiver as recited in claim 11 wherein the portion of super cell transmission points is semi-statically configured based on the user equipment measurement of channel state indicators corresponding to all super cell transmission points.

16. A method of operating a transmission mode-switching receiver for use with user equipment in a network MIMO super cell, comprising:
receiving a transmission for the user equipment within the network MIMO super cell; and
processing the transmission, wherein the transmission is supplied from a portion of super cell transmission points.

17. The method as recited in claim 16 wherein the portion of super cell transmission points corresponds to a single transmission point determined by the user equipment.

18. The method as recited in claim 16 wherein the portion of super cell transmission points as indicated by the user equipment is overridden to provide the transmission from another portion of super cell transmission points.

19. The method as recited in claim 16 wherein the portion of super cell transmission points is semi-statically configured corresponding to a joint report from the user equipment or a performance target for the user equipment.

20. The method as recited in claim 16 wherein the portion of super cell transmission points is semi-statically configured based on the user equipment measurement of channel state indicators corresponding to all super cell transmission points.
